(19) United States
(12) Patent Application Publication
(10) Pub. No.: US 2017/0148435 A1
(43) Pub. Date: May 25, 2017

(54) Unknown

(71) Applicant: LIFEASSIST TECHNOLOGIES, INC, SAN FRANCISCO, CA (US)

(72) Inventor: GARY ROTMAN, Thornhill (CA)

(21) Appl. No.: 14/097,201

(22) Filed: Dec. 4, 2013

(51) Int. Cl. G10L 15/22; G04G 21/00; G04G 13/02; G04G 21/06; G04G 9/00; G04G 9/08

(52) U.S. Cl. CPC G10L 15/22; G04G 9/007; G04G 9/08; G04G 13/026; G04G 21/06; G04G 21/00; H04M 1/72527

(57) ABSTRACT

A device which operates as an intelligent hands free voice activated Reminder device on its own or as part of any device, or when connected to any network in the home or work, which incorporates a reminder and control system that announces and/or displays personalized scheduled messages and/or voice reminders of any length, either pre-recorded in a personal voice or a voice of a pre-recorded person, or a computer generated voice based on reminders and/or tasks at specific time or date or a combination of time, day, date or year.

These reminders can be confirmed by the end users and therefore acknowledged by a second person, whether they are in the same premises of the end user, or anywhere else in the world. The user can ask the device to repeat a reminder for any time, day, date or year. For example, when is my doctor's appointment? Or when is Justin's birthday? What is my mortgage renewal? When is my cell phone contract finished? What are today's reminders? What are all the reminders?

### RELATED APPLICATIONS

This application claims priority to U.S. Provisional application Ser. No. 61/734,540, filed Dec. 6, 2012 and hereby incorporated by reference.

### FIELD OF INVENTION

This invention relates to a device for delivering reminders and or messages to the user or to a another person remotely located, by spoken words into the device, and on its display(s) and at the times programmed into the device by the user, or other person. By either locally speaking commands and messages to the device, and or remotely using a wireless audio and or video device or through an internet connection etc.

### BACKGROUND OF INVENTION

Alarms clocks are known in the prior art, and include digital and analog devices. The clocks of the prior art utilize buttons or knobs to set the timing and alarm functions. A user must therefore look at the alarm clock, and manipulate the buttons or knobs and to set the alarm. When the prior art alarm clock is mounted on a Wall or a high location, the user may need to climb a ladder or other structure to access the clock, creating a potential dangerous situation due to risk of fall. When the prior art alarm clock is a desktop type alarm clock, the user must press buttons to (1) stop the alarm and/or (2) activate a snooze feature.

Alarm clock usually very limited in the number of alarms that may be set and then the alarms are typically limited to a simple alarm sound and or a flashing light.

When the prior art alarm clock is a digital electronic device, the user must execute a complex sequence of steps, i.e., a series of button presses, just to set the alarm clock, time and alarm times.

For example, to set the time to “10:23 PM” and “December 6” in the prior art alarm clock, one typically presses a “Set Clock” button to enter a clock time setting mode, presses a “+” or “−” button to select AM or PM, presses a “SET CLOCK” button to confirm a setting and to change the clock hour, repeatedly presses or holds the “+” or “−” button until the hour digit “10” appears, presses the “Set Clock” button again to confirm the setting and to change the clock minute, repeats the sequence to finish setting the clock minute to “23,” and again repeats a button-pressing sequence to set the calendar to “December 6.”

Disabled or elderly persons with reduced cognitive ability can require reminders for activities of daily living to help live independently, i.e. health or personal or household related. Disabled persons often require uncomplicated solutions. A reminder device which delivers personalized reminders or messages at a specific time delivered without any interaction between the user and the device nor is visually portrayed as a complicated device is not evident in prior art.

### SUMMARY OF THE INVENTION

In one aspect, the device can structurally look like a traditional or modern digital clock, or it could be a part of any device with a display (a microwave or electronic fridge, or a PC or tablet), or any electronic timepiece or wrist wear or wearable on any part of your body.

The device with the reminder system capability can be either powered by an AC outlet or a battery as a mobile device, such as a cell phone. The device can also be connected to a network in your home or work, either wirelessly via its internal wireless interface (Wi-Fi, or a 4G LTE modem or blue tooth) or similar data transfer technology, or via a direct wire network connection (RJ-45), so reminders can be set and or monitored via a networked computer, tablet, or an appropriate cell phone from any location worldwide.

The device will store several audio alarm messages which are spoken into the device and or remotely entered into the device's non-volatile memory, for playback at specific times and dates, over several years as required.

The device will include an “acknowledgement” feature, meaning a manual switch (on the device or via a wireless fob/pendant type device) and or via a voice commanded alarm shutoff, then can alert a caregiver (family member or professional) that the reminder has been or has not been acknowledged by the user.

In one aspect, the device may have pillboxes or containers which hold medications or any small item(s), attached or as part of the device which helps to remind the user/patents to take their medications or for the user to take an action related to that item.

The Reminder device, when connected to a network which has access to the internet, either through a home or office network or via a mobile radio/telephone network, will also have the ability to, when asked verbally a specific question to receive a verbalized reply, or display on its display screen or any attached monitor/TV display screen, important information such as weather alerts/conditions, sports scores, stock quotes, traffic conditions or newsworthy stories or public emergencies either local or worldwide, or on any topic the user requests (if available).

In one aspect, The device will (if equipped) be able to indicate if it has detected that the user has moved in or around the area monitored around the device, i.e. if the motion sensor is placed near the user's bed it can signal the device which delivers a message to a remote person that the user has gotten in and or out of bed or not within the programmed time intervals, allowing the remote person to take necessary action.

In one aspect, the device will be able to monitor any appropriate wireless alarm sensor(s) within range of the device and signal the system's status conditions, such as doors and windows are opened or that they are closed, stove is left on based on pre-set time intervals etc.

The Reminder device functions will be able to be incorporated into any digital, LCD or LED and or similar display, wristwatches or any electronic timepiece. The Reminder timepiece can be incorporated into any device imaginable, ranging from robotic vacuum cleaners to humidifier to mobile phones. Any (APPS) of our software or idea applied to a computer, an appliance or mobile phones.

Any and all languages can be recognized and applied to any device in conjunction with a device that also has WiFi or direct communication to mobile networks. The device can be attached to or be part of in any way with pillboxes or any container of any size and any multiple.

In another aspect, the device will include an AM and or FM radio module that responds to timing and/or alarm functions of the system's time clock scheduler routine. For example, when commanded by voice commands, the device will turn on or off the radio at a specified time.

The Reminder device provides information and instructions to the user as spoken phrases or command instructions via the enclosed audio speaker and on various displays (such as on its internal Clock or color LCD display screen, and on various external TV monitors/display/screens and their speakers. which display the requested information, such as the date and time, and any other requested information etc. to the user.

The Reminder device is based upon one or more microprocessors within each device, which control the recording and play back of Audio messages, the detection of spoken commands, the monitoring of buttons/switches/sensors, the time clock scheduler which generates the alarm events, the annunciating of the time of day, the uploading of the devices memory/status to the network/users and the when to turn on and off the various external devices under the devices controls etc.

### DETAILED DESCRIPTION OF THE INVENTION

The device is complex micro-processor based apparatus, which may be built in various ways, depending on the components selected the number of parts will vary, so as to best illustrate the device's required functionality, they are shown as discrete components in the block diagrams, however a device could be potentially built using one or more parts (1) that could include up to seven of the required functional elements. The items enclosed inside the dashed outline (4, 5, 6, 8, 9, 12 and 15). Which actual parts selected is not material to the design.

A microphone (3) senses the audio, and the Audio processor (5) digitizes (4) and its speech recognition routines decode the detected audio phrases and or commands and sends them on to the Main processor (12), which executes instructions. The Audio processor is programmed to recognize and associate user-chosen audio commands and instructions with specific time and date alarm functions, for example, the alarm clock system may be programmed to activate an alarm function in response to the command “Turn alarm on” or in response to programmed message which is to be delivered at a programmed time on a specific day or for example deliver the message “Dad take four white pills and one blue pill with a glass of water” using the Audio Processor (5) its D/A converter (6) and output via the speaker (7) every day at 9:30 AM etc.

To keep the time base very accurate the Main processor (12) employs a Real Time Clock RTC (9) which always runs even the unit is running off the internal standby Battery pack (14).

Within the Sensor & RTC block (9) are several electronic sensors, i.e. a Temperature sensor for monitoring the room's ambient temperature, one or more Passive IR sensors for detecting the user's approach or detecting movement near or around the device's sensor or via other external sensors communicating to the device; a stove sensor, door sensor, water leak sensor, Carbon Monoxide sensor, etc. “turn off your stove”, lock your door”, “close the fridge”. If reminders are not acknowledged by the user within a pre-set time frame, a message is sent to a remote person.

The Audio prompts generated by the Audio processor's Digital to Analog converter (6) are sent to the internal speaker (7) and to the optional external speaker(s). There are symbols & messages shown on the various displays on or connected to the Reminder device, to assist the user in its programming and the recording of Voice commands, messages and instructions which are stored internally in non-volatile memory (8) for use by the Audio (5) and Main (12) processors of the Reminder device.

The Main processor (12) maintains the time clock scheduler, which it synchronizes to the battery backed up RTC (9) clock. When power is applied to the device by its DC in connector (17), the processors start checking for messages and alarms that should have been delivered during the battery backed-up interval, and immediately plays them to the user and awaits their acknowledgment.

When the device has access to the internet (25), it will at scheduled intervals adjust the RTC (9) and the time clock scheduler to the Internet's time clock. In this manner the devices clocks will never be off by more than a few seconds in any day, i.e. until the next update cycle occurs.

The Main processor (12) also captures the video from the camera (11), and handles all the graphic display(s) (16 & 21) functions, the networking (10 & 13) communication routines, and the various remote control functions.

A Wireless transceiver (10) and corresponding control firmware will be installed into the Reminder device to permit the Main processors (12) alarm/clocking functions to control and the monitoring of all the external electronic devices/sensors, such as, a the wireless remote “Assistance/Panic” push button, a fridge, the various room Lights, television, a coffee machines and/or other types of devices etc. connected to its network.

In one aspect, when the device is connected to the web the Main processor (12) would capture video of the user from the camera (11), and using the graphic display(s) (16 & 21), the Audio processor's (5) audio capture [Microphone (3), A/D (4)] & playback functions [D/A (6), Speaker (7)], and “Skype” compatible software. Provide as means for health practitioners, family members, and caregivers to communicate with the User.

In one aspect, the device can be commanded to display stored pictures from its internal memory, or when it is connected to the web, by using the networking interfaces (10 & 13) and related communication routines, it can downloaded images, so it functions as electronic picture album or as a message board and or as an internet TV.

### DESCRIPTION OF THE DRAWINGS

In drawings which illustrate embodiments of the invention,

FIG. 1 is a block diagram of the Reminder Device with optional external display and wireless keyboard.

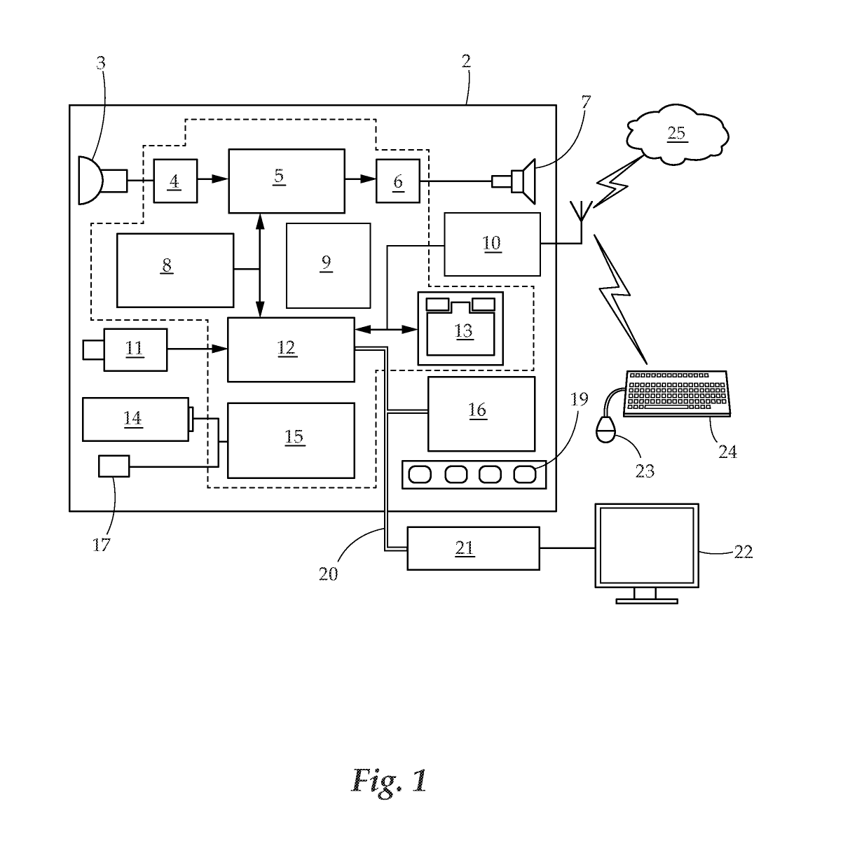

FIG. 2 is a block diagram of an Office Reminder Device with a wireless interface to various sensors.

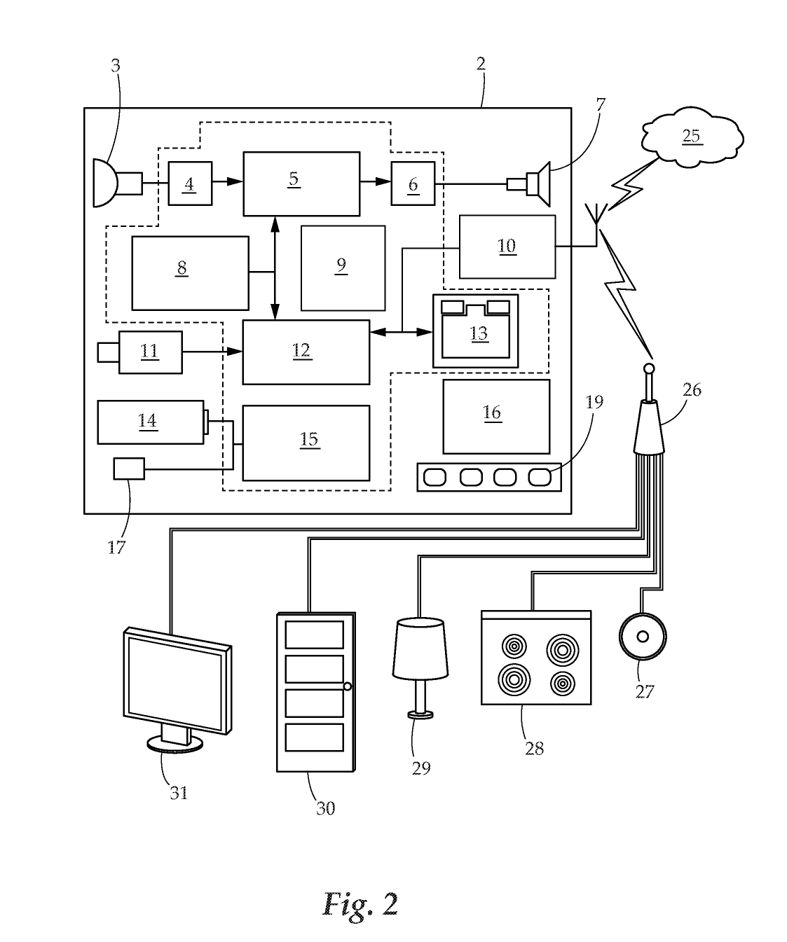

FIG. 3 is a block diagram of an Home Reminder Device with a wireless interface to various optional sensors.

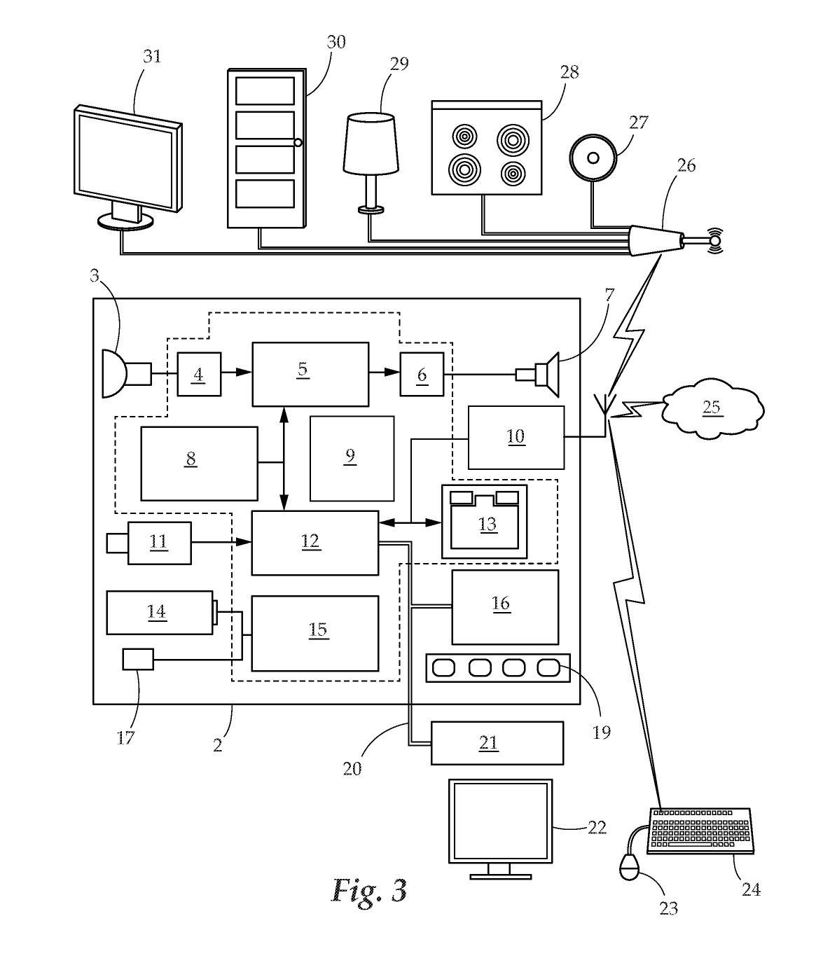

FIG. 4 is a Front view of the Reminder Device using a clock (seven segment) display, showing the placement of the Microphone and the Video Camera.

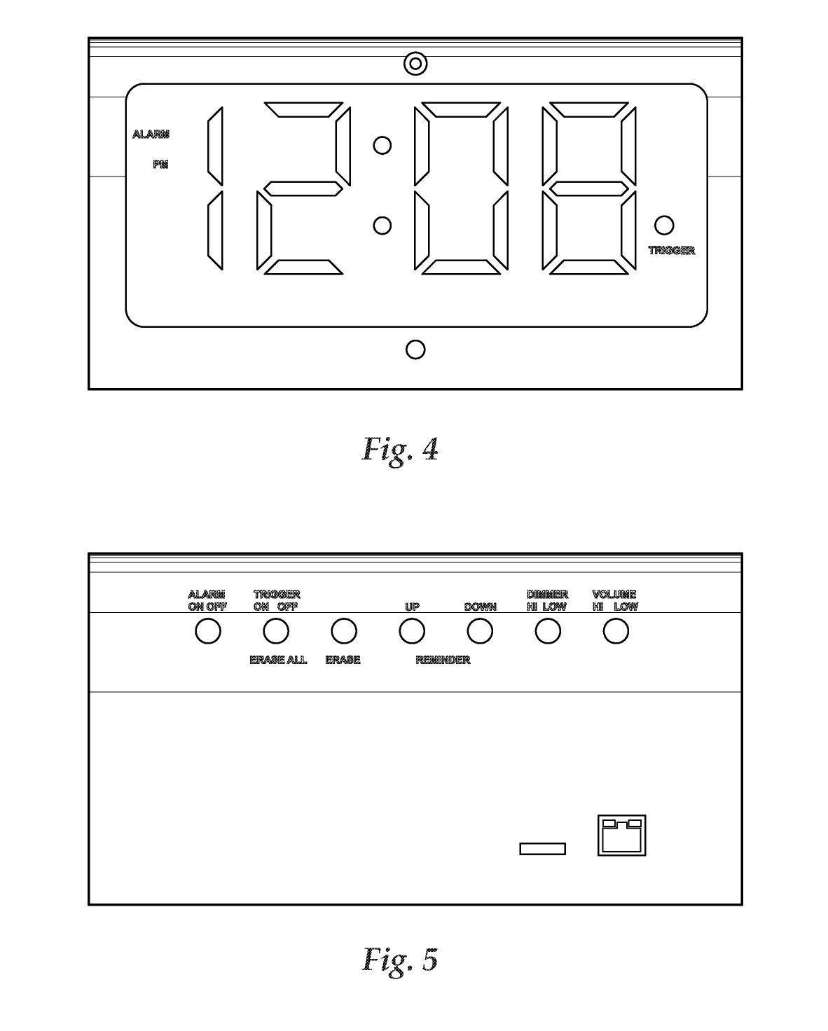

FIG. 5 is a Rear view of the Reminder Device, showing the placement of the Push button, the HDMI video output connector and the RJ-45 Ethernet connector.

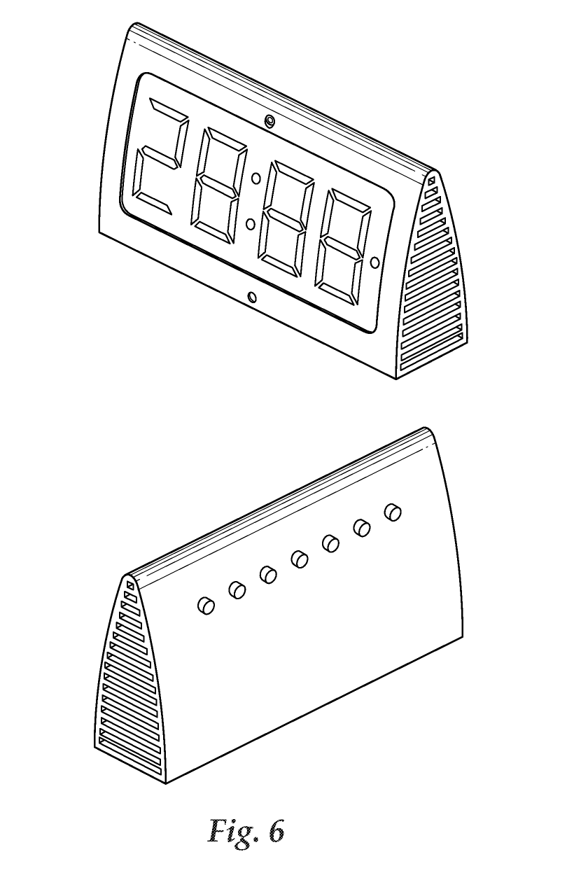

FIG. 6 is a Front and Rear 3D view of a minimal implementation of the Reminder Device,

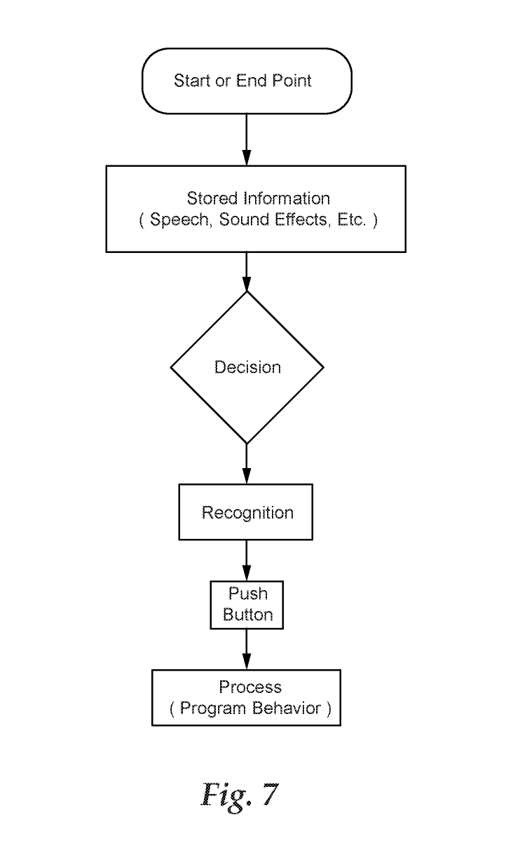

FIG. 7 illustrates the symbols used in the flow charts.

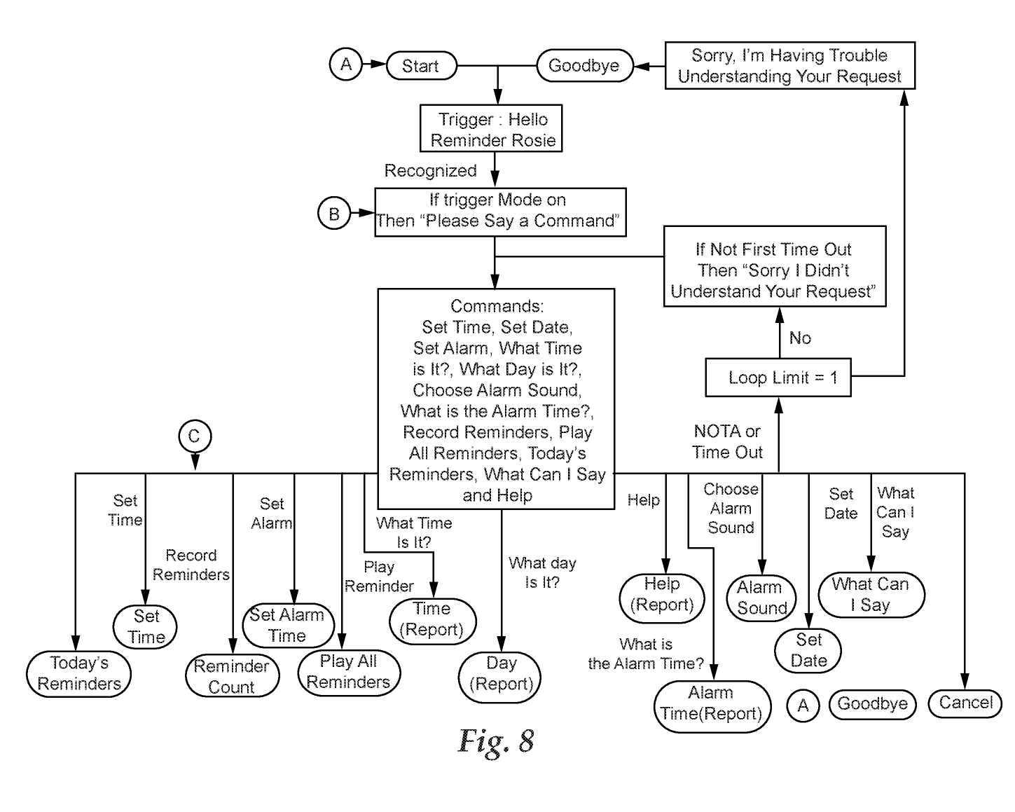

FIG. 8 is a flow chart for an exemplary “Main” Audio Command Decoder.

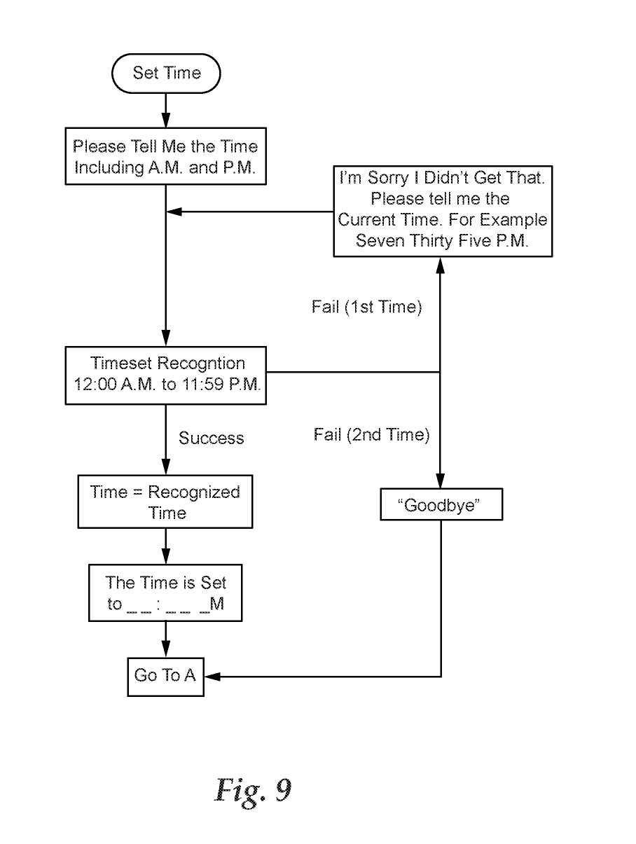

FIG. 9 is a flow chart for an exemplary “Set Time” Audio Command Recognition routine.

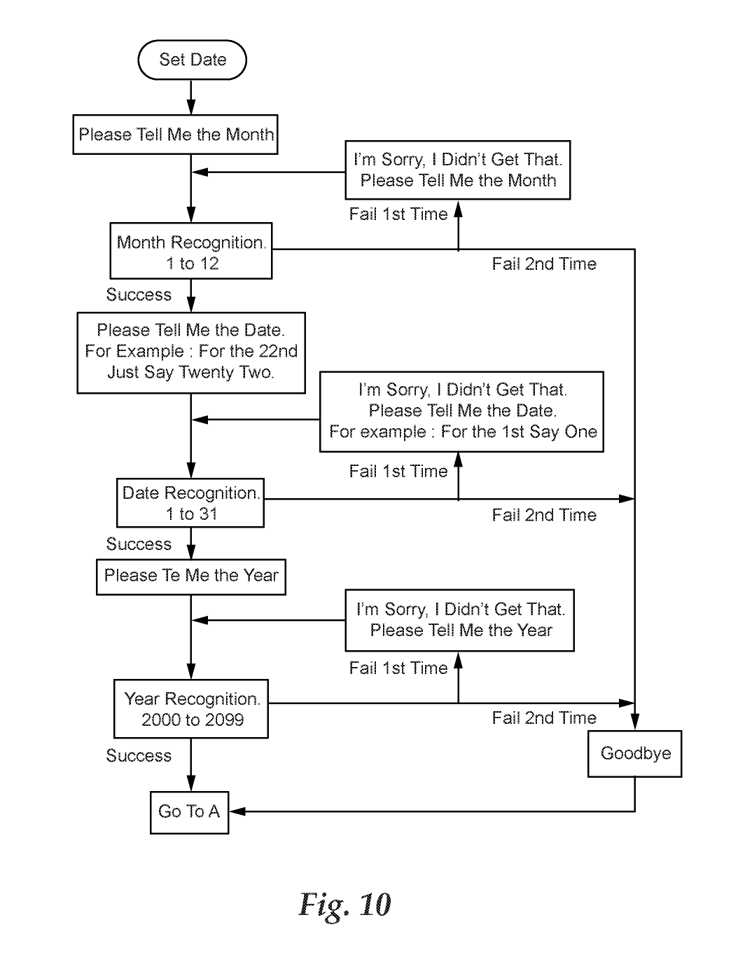

FIG. 10 is a flow chart for an exemplary “Set Date” Audio Command Recognition routine.

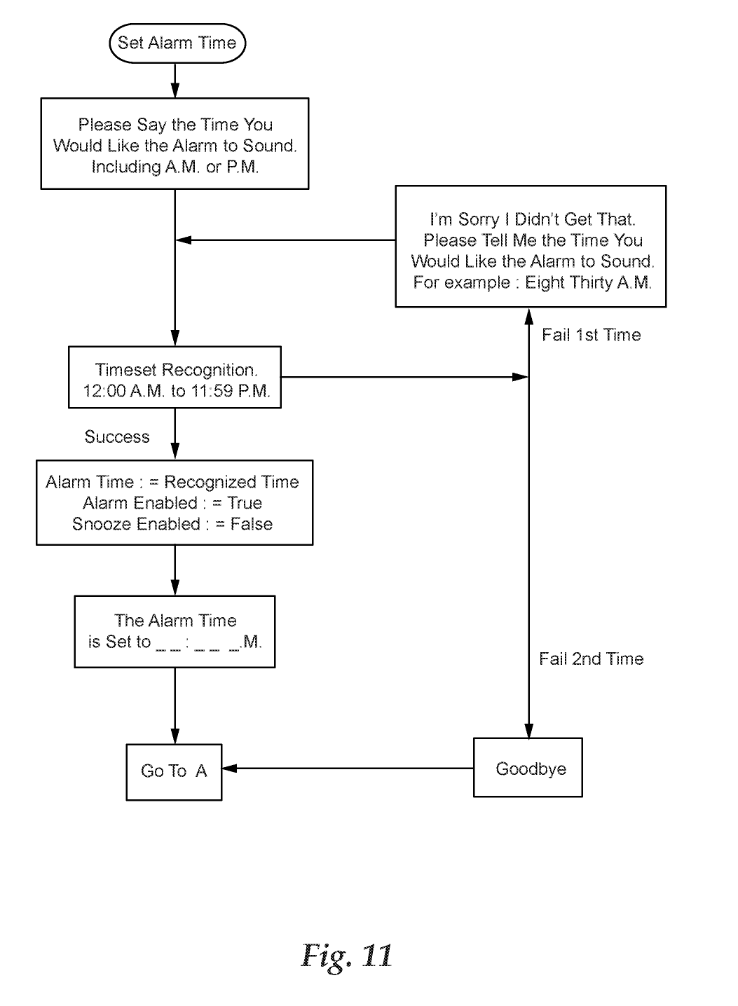

FIG. 11 is a flow chart for an exemplary “Set Alarm Time” Audio Command Recognition routine.

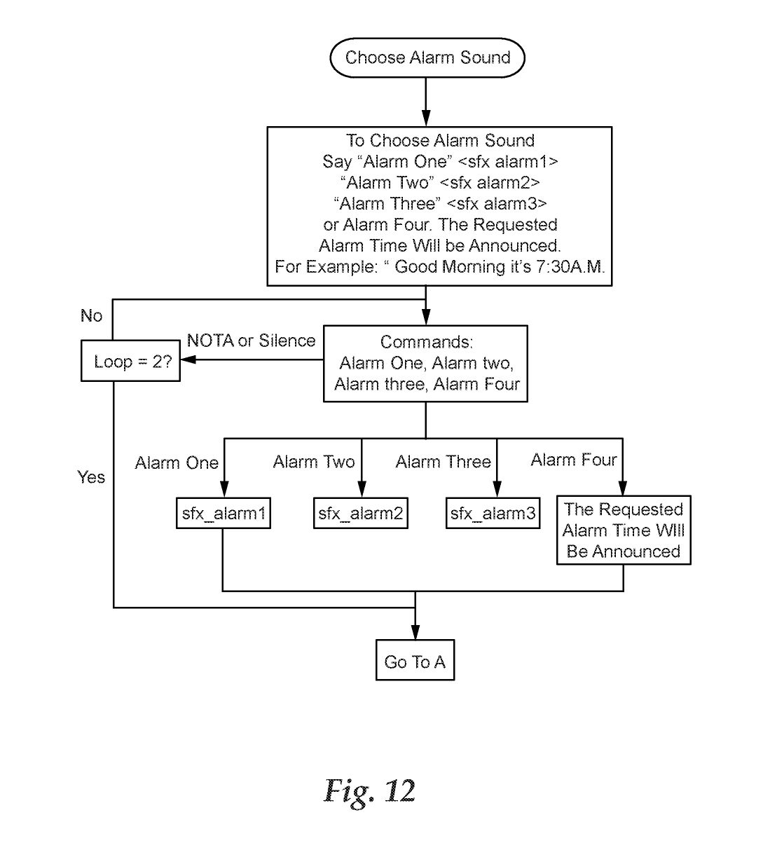

FIG. 12 is a flow chart for an exemplary “Choose Alarm Sound” Audio Command Recognition routine.

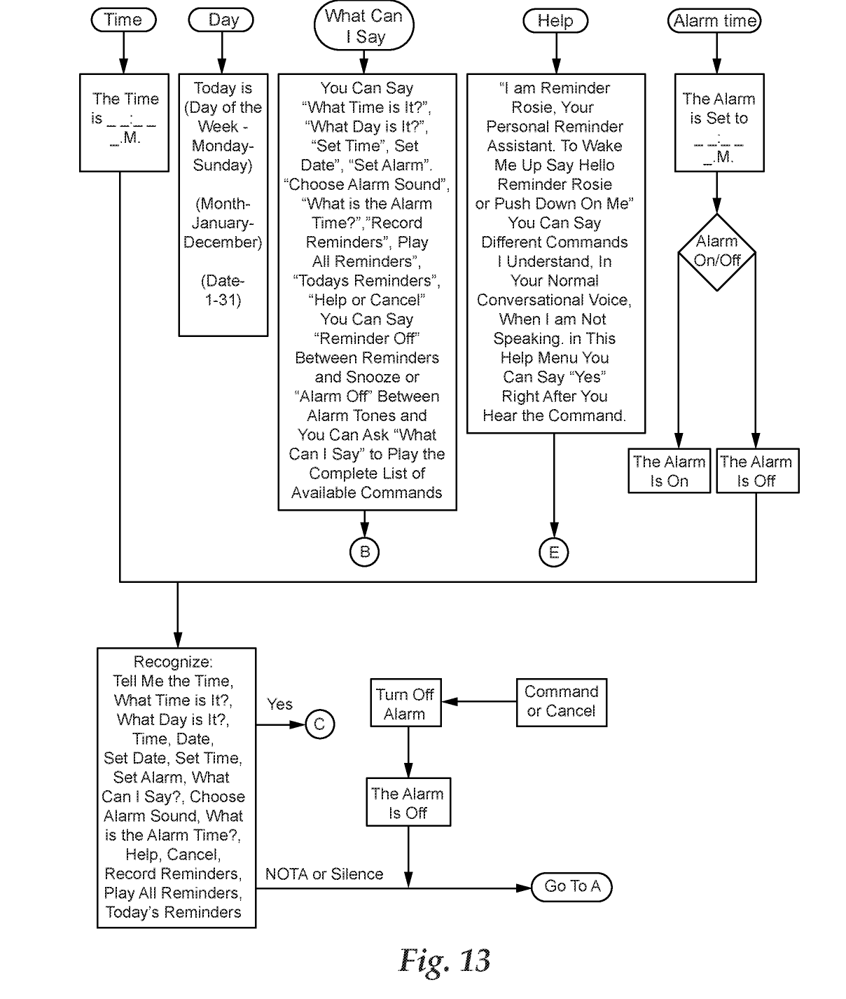

FIG. 13 is a flow chart for an exemplary “Report” Audio Command Recognition routine.

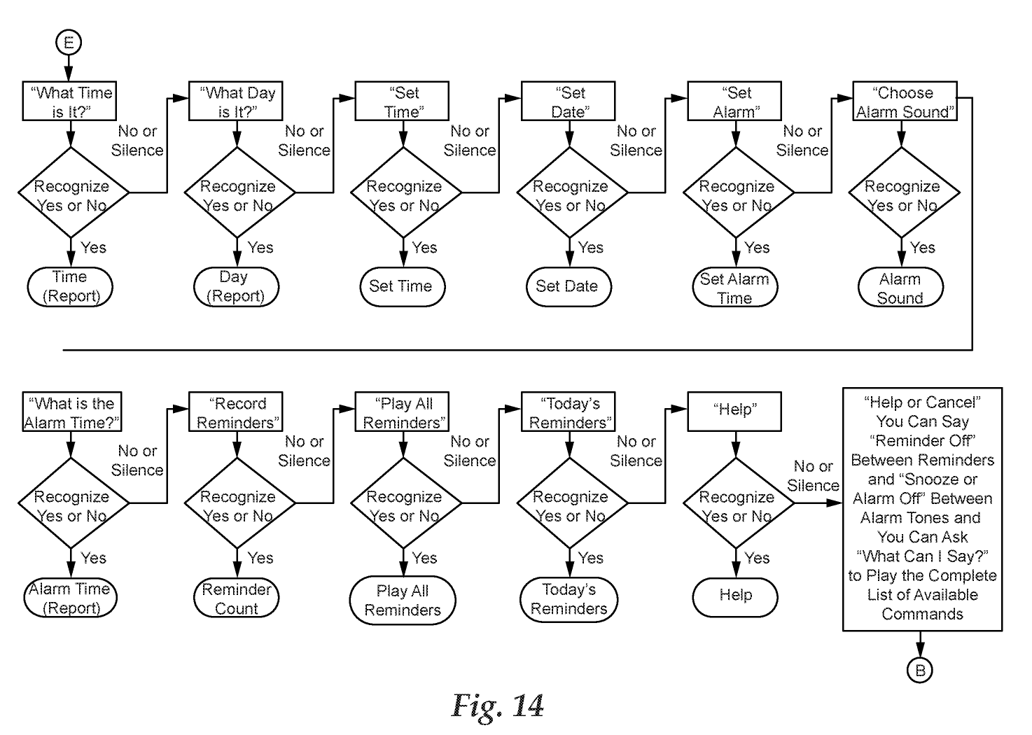

FIG. 14 is a flow chart for an exemplary “Report Help” Audio Command Recognition routine.

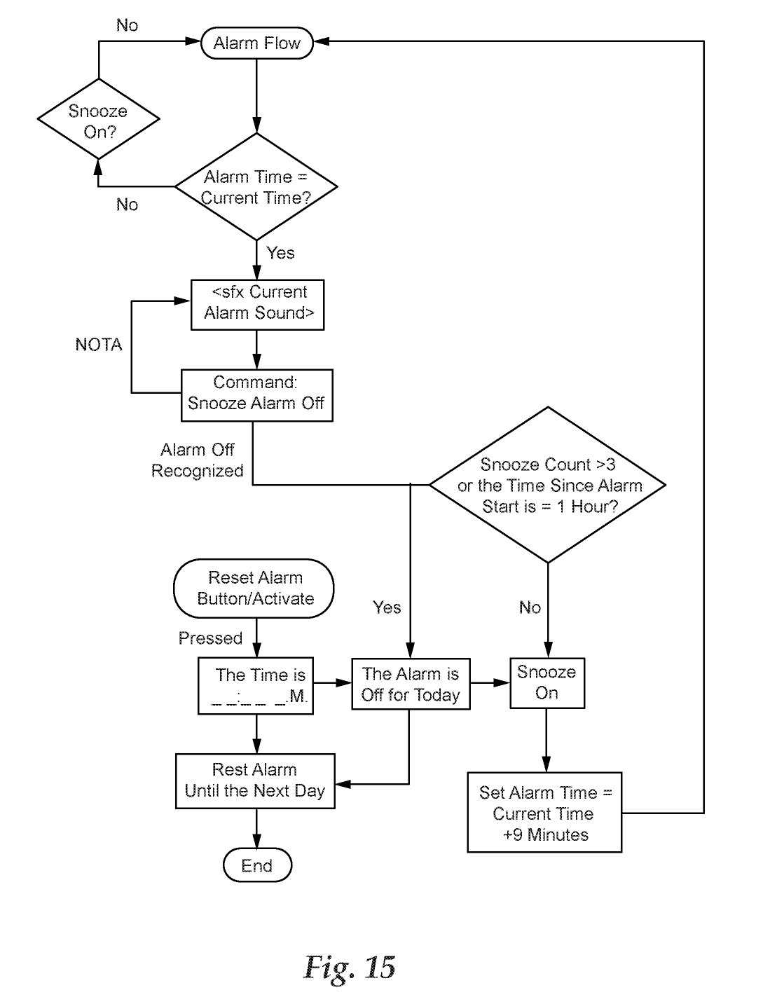

FIG. 15 is a flow chart for an exemplary “Alarm” Command processing routine.

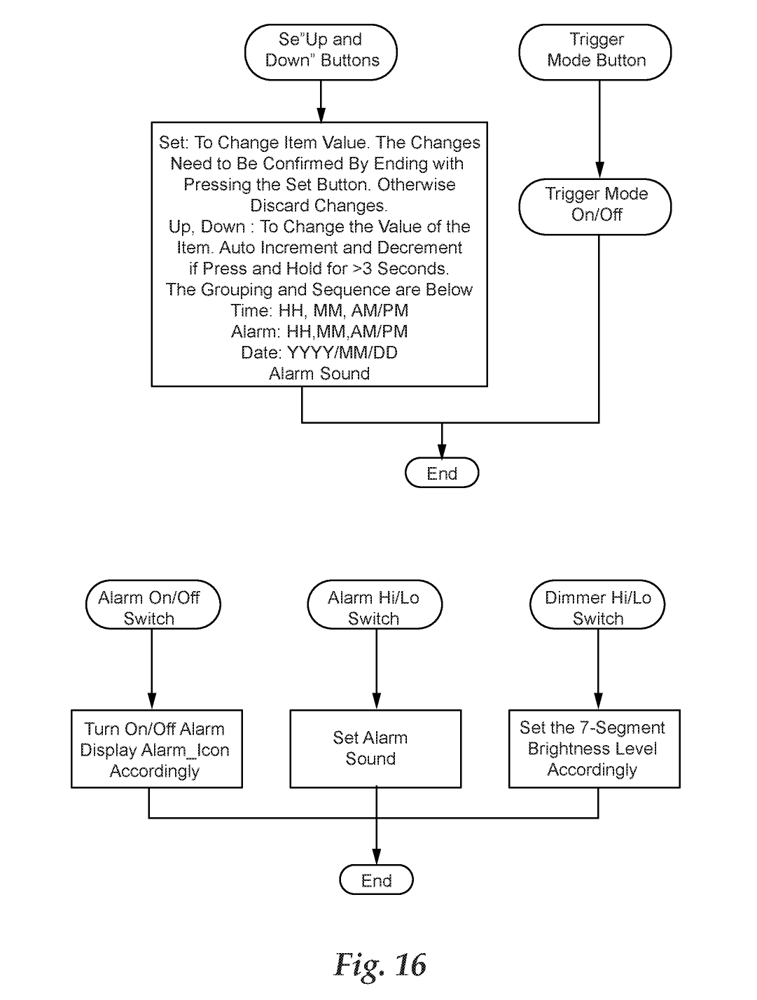

FIG. 16 is a flow chart for an exemplary “Buttons and Switches” Command processing routines.

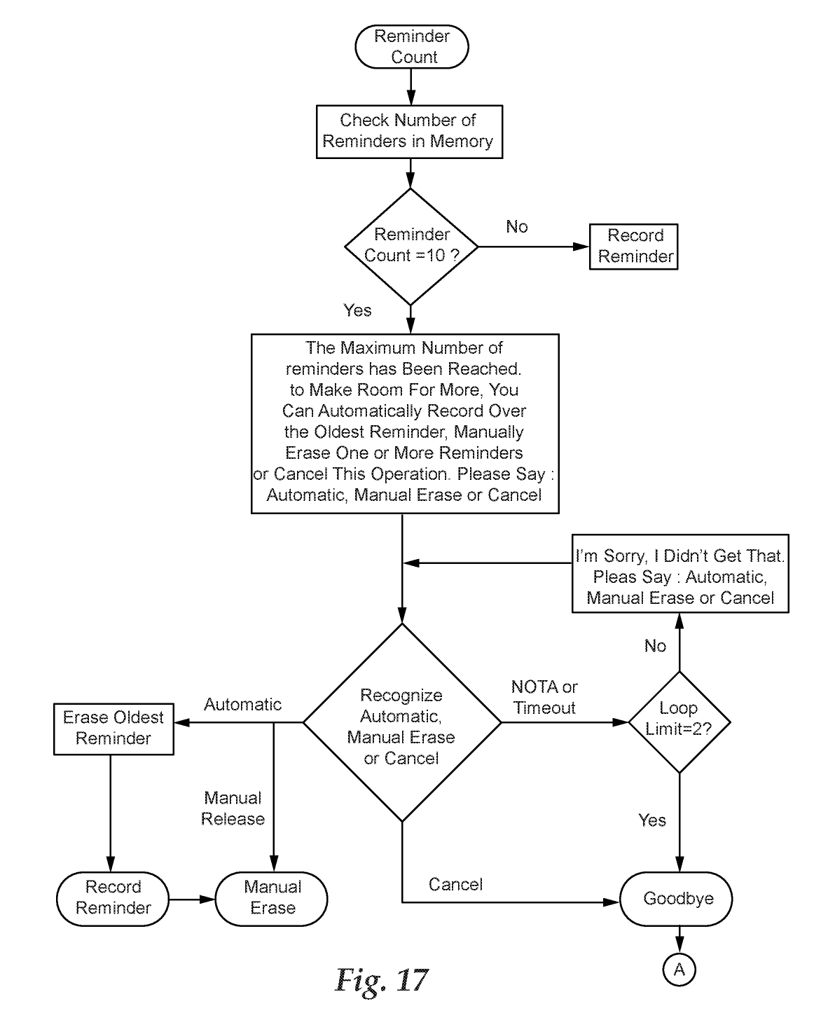

FIG. 17 is a flow chart for an exemplary “Reminder Count” Command processing Reminder Saving routine.

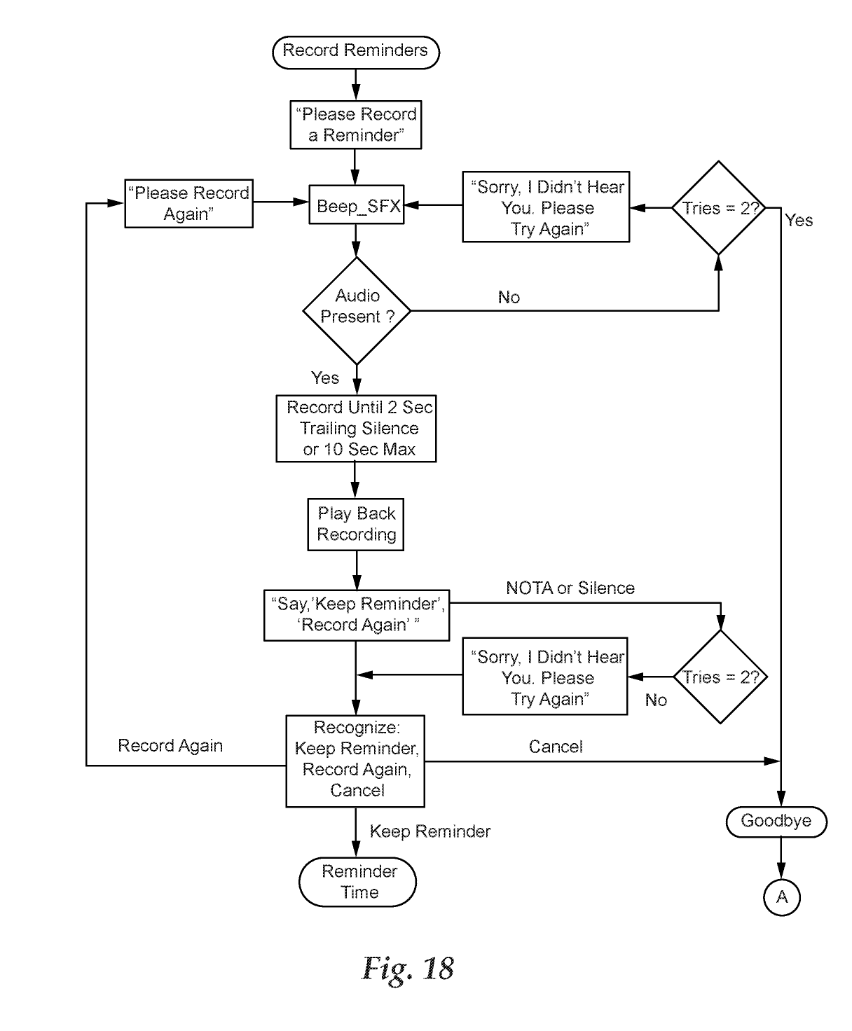

FIG. 18 is a flow chart for an exemplary “Record Reminders” Command processing Reminder Recording routine.

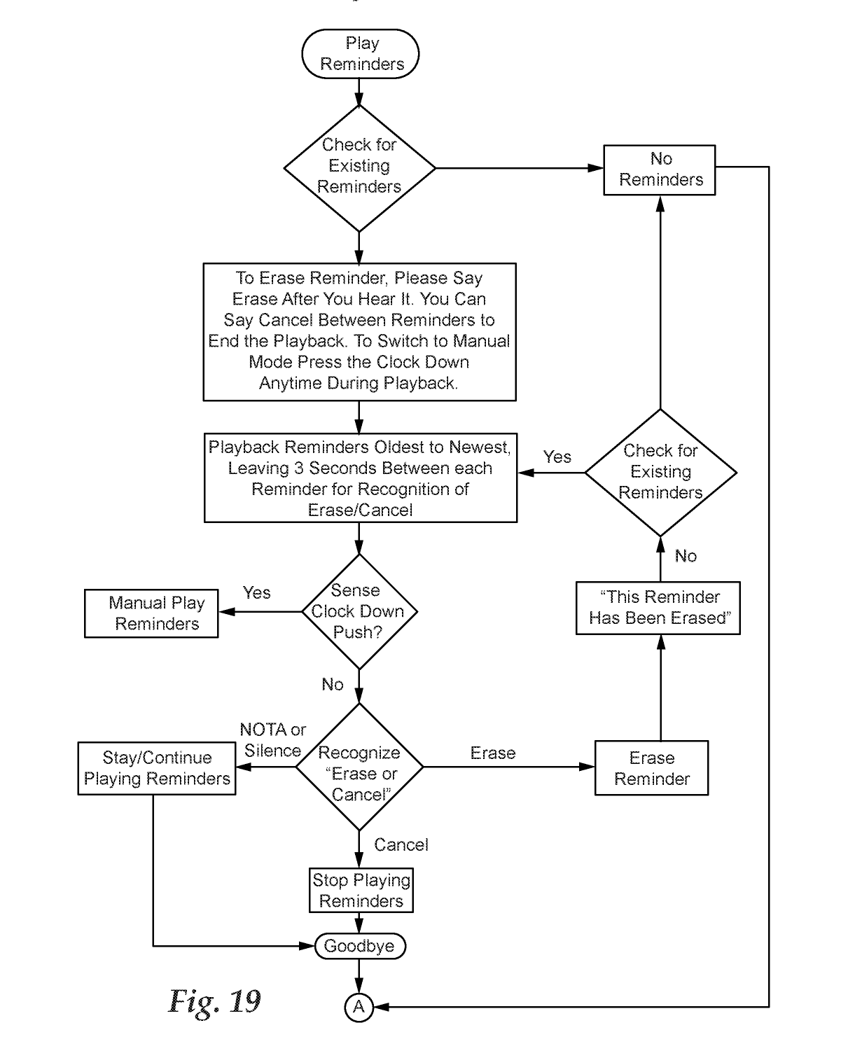

FIG. 19 is a flow chart for an exemplary “Play All Reminders” Command processing Play All Reminder Recordings stored routine.

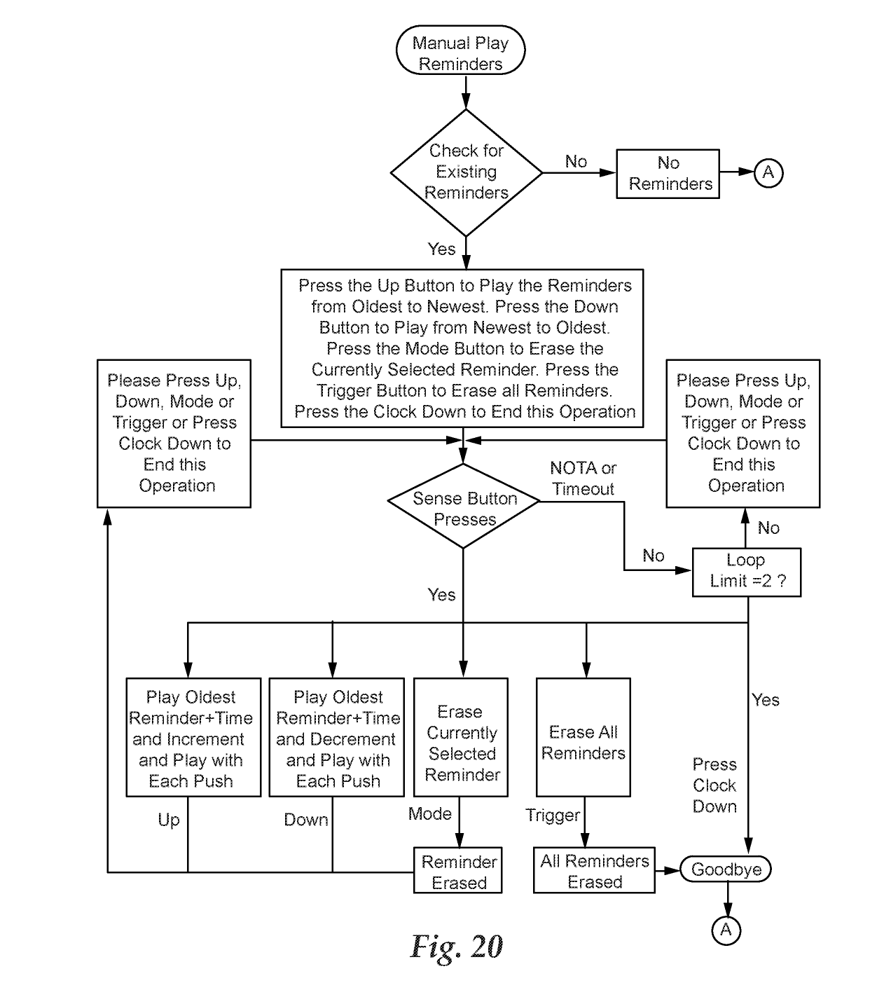

FIG. 20 is a flow chart for an exemplary “Manual Play Reminder” Command processing Manual Playback Reminder of stored Recordings routine.

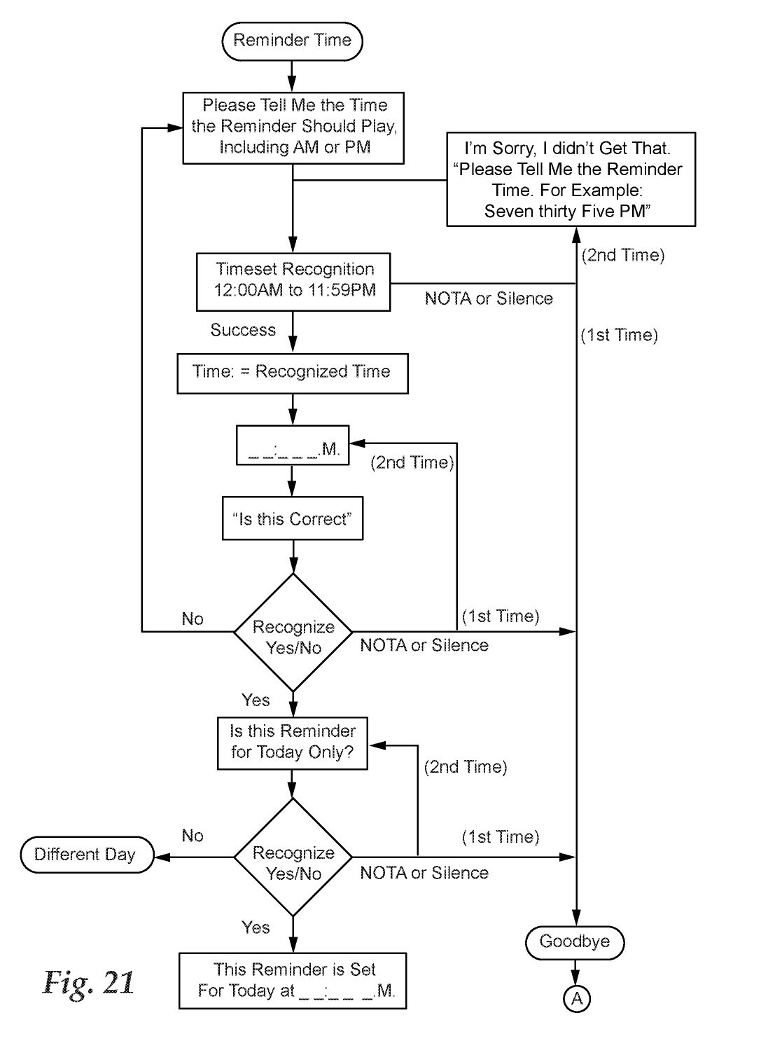

FIG. 21 is a flow chart for an exemplary “Reminder Time” Command processing Reminder Time programming for a stored Recording routine.

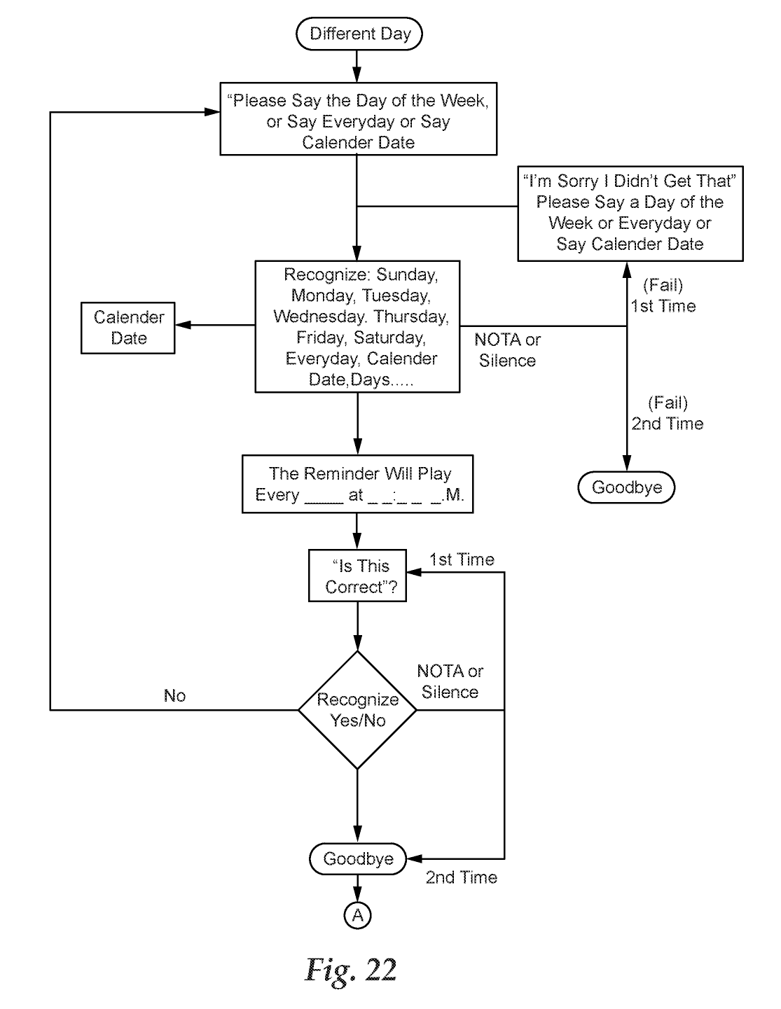

FIG. 22 is a flow chart for an exemplary “Different Day” Command processing Different Day Reminder Time programming for a stored Recording routine.

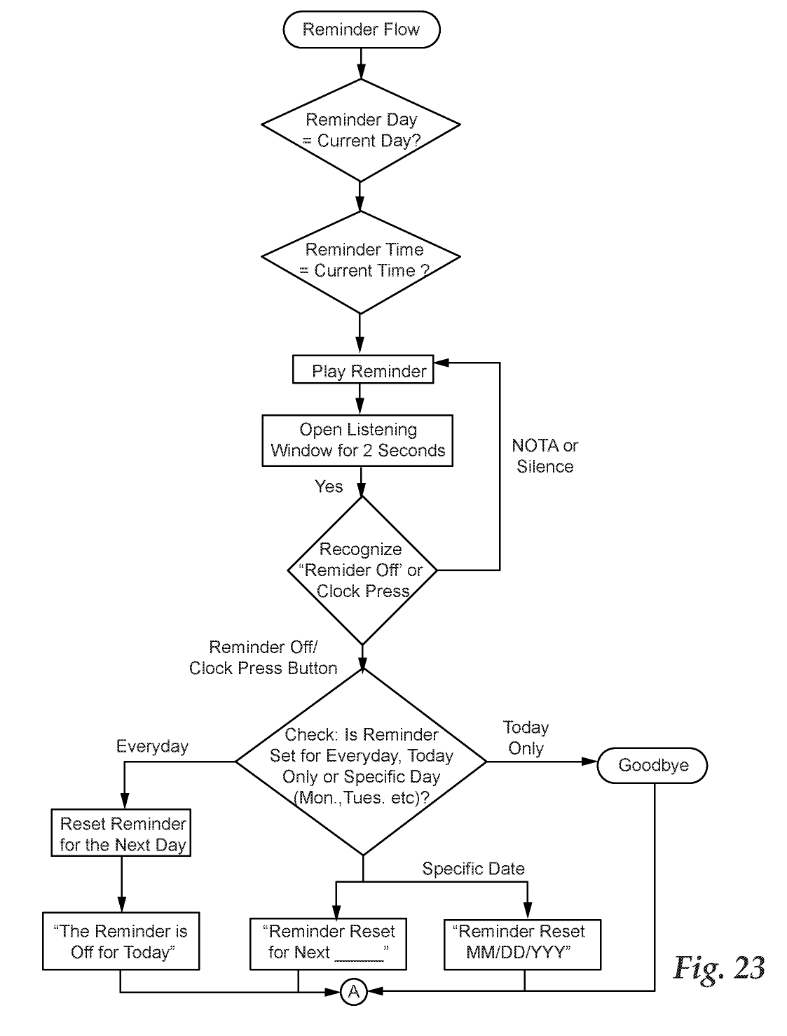

FIG. 23 is a flow chart for an exemplary “Reminder Flow” Command processing Reminder message playback Time and Acknowledgement command recognition programming for a stored Recording routine.

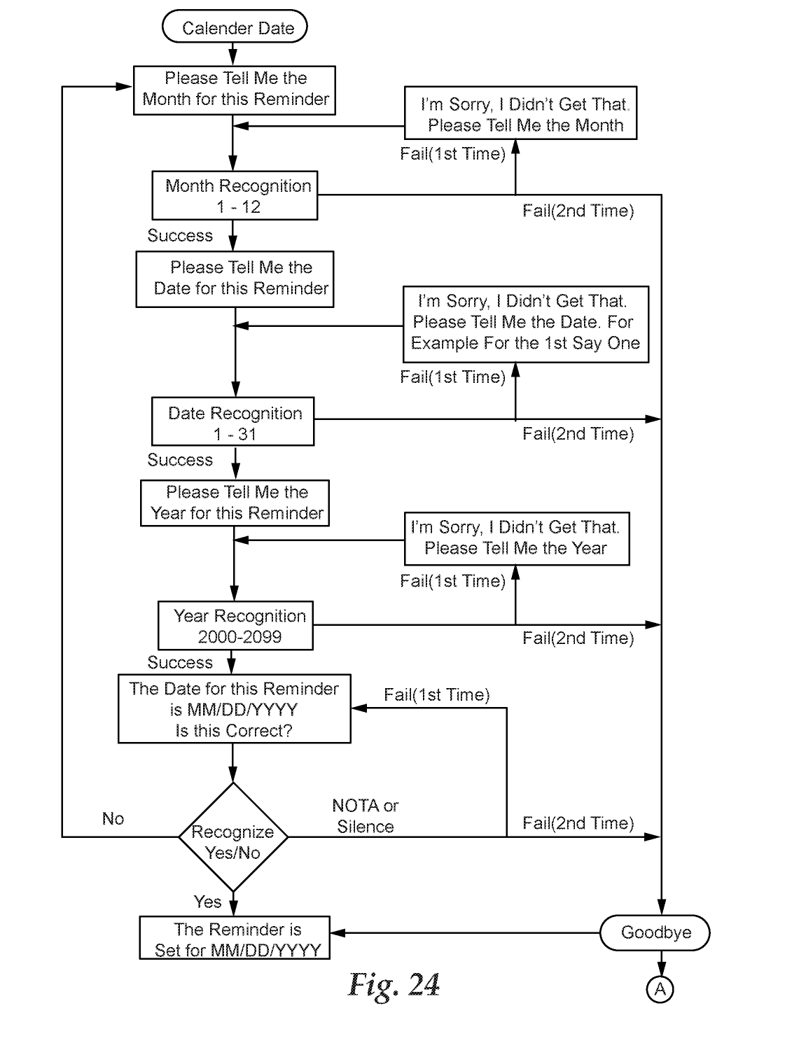

FIG. 24 is a flow chart for an exemplary “Calendar Date” Audio Command processing Reminder message playback Time and Date programming for a stored Recording routine.

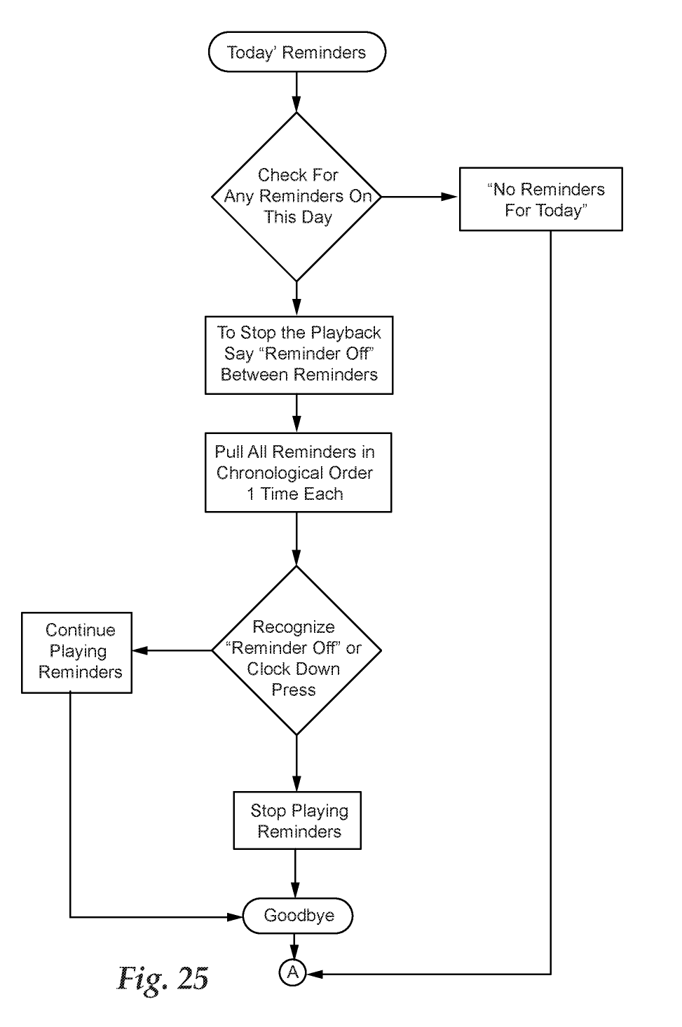

What is claimed is:

1. A device for delivering reminders and or messages to the user, by spoken words, digitized audio/video recordings or sounds & images on various displays that are either part of the device and or remotely mounted and connected to the device.

2. The messages can be entered into or retrieved from the device, by the user simply speaking in a normal voice, using a list “Command” phrases, to signal the device what the user wants the device to do and when.

3. The messages can also be entered into or retrieved from the device, remotely by the user simply using a wireless microphone and or through an internet or web type interface.

4. The messages are audio-video recordings and they are not of fixed length, as the messages are digitized recordings, they are not limited to any specific language.

5. The device uses a stored library of Standard English commands phrases. These command phrases can be downloaded with a replacement audio command library in another language.

6. Additional commands can be added to the library to support future additional functions.

7. A device with a microphone, a digitizer, an audio output amplifier, speaker, a basic network interface, an appropriate display, memory both non-volatile and dynamic, sufficient processing resources can be made to perform as the basic Reminder device, using the developed firmware routines.

8. The complete device functionality requires additional electronic parts, but if their equivalent functionality was available through the network interface, the full library of features and or functions could be implemented.

9. The device messages will be fully programmable by the user, a doctor, or any other person. By either locally speaking commands and messages into the device, and or remotely using a wireless audio microphone or video camera and or through an internet connection etc.

10. A device as claimed in claim 5 wherein said controller comprises a digitizer, said electronic memory, a sequencer and a digital processor, said digitizer receives the audio command phrases from said sensors and digitizes each audio string/phrase, said sequencer monitors said digitized signals and filters and enhances the signal and then if it determines a match with one or more of the stored reference command phrases, and then said digital processor retrieves from said command look up table said the appropriate sequence and data instructions of what to do and when, and then schedules for the playback of specific messages and or stored digitized audio-video messages to be played at the allotted time
